(19) United States
(12) Patent Application Publication
(10) Pub. No.: US 2005/0106980 A1
(43) Pub. Date: May 19, 2005

(54) Fully elastic nonwoven-film composite

(76) Inventors: Jean Claude Abed, Peine (DE); Henning Roettger, Braunschweig (DE); Steven P. Webb, Midland, MI (US)

Correspondence Address: O'KEEFE, EGAN & PETERMAN, L.L.P;Building C, Suite 200, 1101 Capital of Texas Highway South, Austin, TX, 78746, US

(21) Appl. No.: 10/924,271

(22) Filed: Aug. 23, 2004

Related U.S. Application Data
(60) Provisional application No. 60/497,147, filed on Aug. 22, 2003.

(51) Int. Cl. B32B 27/12; B32B 5/22; B32B 31/08; B32B 27/00

(52) U.S. Cl. 442/395; 442/399; 442/381; 442/392; 442/361; 156/290; 156/291

(57) ABSTRACT

This invention concerns an elastic multilayer composite, comprising an elastic film layer sandwiched between a first elastic nonwoven layer and an optional second elastic nonwoven layer, and a process for making the same. The laminate is stabilized via bonding according to either: adhesive bonding between the film and nonwoven layer(s), direct extrusion lamination of the film to one or more nonwoven layer(s), or attachment of the film to one or more of the nonwoven layers at a plurality of points via thermopoint bonding. This invention also concerns a process for manufacturing an elastic multilayer composite, comprising: bonding under neutral tension or substantially neutral tension at least one elastic film layer to at least one elastic nonwoven layer. This invention also concerns a process for manufacturing an elastic multilayer composite, comprising: bonding under differential tension or stretch at least one elastic film layer to at least one elastic nonwoven layer, where either the film or the nonwoven or both are stretched Further the invention relates to a process whereby the elastic nonwoven(s), the film, the composite or any combination is activated, especially stretch activated, to create or enhance elasticity or the touch of the nonwoven, to create pores in the elastic film, or to soften the composite.

This application claims priority to U.S. provisional applications Ser. No. 60/497,147, filed Aug. 22, 2004.

### FIELD OF THE INVENTION

This invention generally pertains to multilayer composites formed from at least one elastic nonwoven layer and at least one elastic film layer, and processes used to make such composites.

### BACKGROUND OF THE INVENTION

An elastic composite material typically refers to an elastic material comprised of either multicomponents or multilayers, with one of the layers or components being elastic. Three examples of this are “Stretch bonded Laminates” (U.S. Pat. No. 5,226,992), “Neck bonded Laminates” (U.S. Pat. No. 5,952,252) and “Incrementally Stretched Laminates” (U.S. Pat. No. 5,861,074). The main purpose of the nonwoven is to provide a more pleasing tactile feel to the composite. In these composites an elastic material is laminated to a non-elastic nonwoven. In the case of stretch bonded laminates, the elastic is stretched during the lamination process. When the stretched tension is released, the laminate contracts and causes the nonwoven layers to buckle and fold. In the case of neck bonded laminates, the non-elastic nonwoven layers are prestretched, so that they have very low resistance to extension.

However, these prestretched layers do not have significant recovery force, and must be laminated to an elastic material to yield a composite with significant elastic recovery. In the case of incrementally stretched laminates, a laminate is formed between an elastic material and one or two non-elastic nonwovens. This laminate is subsequently processed through an incremental stretching device, which elongates the filaments of the nonwoven. These elongated filaments are able to follow the elastic component when it stretches, up to the stretch limits imposed by the incremental stretching process. All of these laminates are disadvantaged by the fact that an additional process step is required beyond the basic lamination step.

The present inventors have recognized a need for a fully elastic composite which does not require activation and/or which does not require manufacture under tension.

### SUMMARY OF THE INVENTION

The present invention provides a solution to one or more of the disadvantages and deficiencies described above.

This present invention describes a product comprised of elastic film and elastic nonwoven components laminated to each other to produce a fully elastic nonwoven-film composite. The elasticity of all of the parts would result in the following improvements over current products: elimination of the need for any and all pre-activation steps of the nonwoven, the formation of a more cloth-like, flat fabric, improved abrasion resistance and conformity of the nonwoven as a composite, and improved overall elastic performance of the composite.

In one broad respect, this invention is an elastic multilayer composite, comprising an elastic film adjacent to an elastic nonwoven layer. By adjacent it is meant that the layers can be directly in contact or can be separated by other layers of non-elastic nonwoven layer, adhesive, a non-elastic layer, or layer of some other material. The elastic film layer can be bonded, such as by lamination, to the elastic nonwoven layer. Advantageously, the process employed to make the composite can be practiced in the absence of an activation of the nonwoven. In another broad respect, this invention is an elastic multilayer composite, comprising an inner elastic film layer sandwiched between a first elastic nonwoven layer and a second elastic nonwoven layer.

In another broad respect, this invention is a process for manufacturing an elastic multilayer composite, comprising: bonding an elastic film layer to an elastic nonwoven layer. The bonding may be via either adhesive, extrusion lamination, or thermopoint bonding (calendaring). This bonding can be conducted under neutral tension. By neutral tension it is meant by neutral such that the amount of tension used is no more than that needed to move the materials from roller to roller. The tension refers to tension in the machine (or cross-machine) direction applied to the layer(s) prior to bonding, as opposed to pressure that may be employed to thermopoint bond the composite. Thus, there may be some slight amount of tension to overcome inertia and friction and therefore the amount of tension can be substantially neutral as understood to one of skill in the art.

In another broad respect, this invention is a process for manufacturing an elastic multilayer composite, comprising: bonding an elastic film layer to a first elastic nonwoven layer and an second elastic nonwoven layer, where the elastic film layer is sandwiched between the first and optional second nonwoven layers. The process can be run under neutral tension or substantially neutral tension.

In another broad respect, this invention is a process for manufacturing an elastic multilayer composite, comprising: bonding under differential stretch an elastic film layer to a first elastic nonwoven layer and, optionally, to a second elastic nonwoven layer, where if boned to both the first and second elastic nonwoven layers, the elastic film layer is sandwiched between the first and optional second nonwoven layers.

In any embodiment of the invention, either the film or the nonwoven(s) may be stretched prior to bonding. Likewise, the composite can be stretch activated after being produced.

As used herein, the elastic film layer can be in the form of a monolithic or multilayered film, foam, net, scrim, mat, or other similar structure. In one embodiment, the elastic film layer is breathable.

### BRIEF DESCRIPTION OF THE DRAWINGS

FIG. 1 shows an extrusion lamination process that may be used in the practice of this invention.

FIG. 2 shows a melt adhesive lamination process that may be used in the practice of this invention.

### DETAILED DESCRIPTION OF THE INVENTION

While additional layers can be added to the composite of this invention, the basic structure of the composite can be referred to as an A-B structure where “A” is an elastic nonwoven layer and “B” is an elastic film or web layer. Alternatively, the composite can have an A-B-A or B-A-B structure, or other multilayer composite structure, including structure that have non-A or non-B layers (excluding adhesive layers). It should be understood that an adhesive may be employed to laminate the A and B layers together. Likewise, multilayer composites having more than three layers are within the scope of this invention, including composites made of one or more layers other than A and B.

Elastic nonwoven fabrics can be employed in a variety of broad applications such as bandaging materials, garments such as workwear and medical gowns, diapers, support clothing, incontinence products, diapers, training pants, and other personal hygiene products because of their potential breathability as well as their ability to allow more freedom of body movement than fabrics with more limited elasticity.

The film-nonwoven composite could be produced by the following methods:
1. Extrusion lamination of the film onto an elastic nonwoven.
2. Extrusion lamination between two separate elastic nonwovens.
3. Adhesive lamination to/between one or more elastic nonwovens.

Alternatively, the composite can be manufactured by casting (direct or off-line), especially with aqueous dispersions, the film layer onto the elastic nonwoven layer, the film layer onto the elastic nonwoven layer. Another alternative method is by of thermally bonding, either directly or off-line, either directly or off-line, to form thermal bonded laminates, such technique being described in U.S. Pat. No. 5,683,787, incorporated herein by reference. All of the above lamination techniques could be accomplished under neutral tension between the film and the nonwoven.

The resulting composite would be fully elastic and could be used directly in a product without any additional activation. Also, while the elastic nonwoven can be activated, that is, further enhanced by stretch activation, before or after lamination, activation is not required. Thus, there would not necessarily be a need to pre-activate the elastic nonwoven prior to, or after, bonding such as by lamination.

In another aspect of the invention, a “pre-elastic” nonwoven is used. In this case the pre-elastic nonwoven can be activated to introduce elasticity and then be laminated to the film or the laminate can be fashioned and then followed by activation. The nonwoven is ultimately self-elastic, that is it could be discerned as elastic in the absence of the film following activation (i.e., >65% recovery after 50% stretch). Activation is an additional step in this case, but it can introduce superior feel to the nonwoven and improved drape to the composite laminate. Activation can be conducted by well known techniques. In one embodiment, if activation is desired, the nonwoven is activated so that that its tensile strength is lessened, generally lessened so that the tensile strength is below that of the film (whether or not the nonwoven has a tensile strength below that of the film prior to activation). Activation may be conducted by an initial drawing or stretching process. Traditional stretching equipment associated with wide web products include conventional draw rolls and tenter frames. The activation process may be accomplished by any drawing or stretching process known in the art, including incremental stretching, tentering, roll drawing, and the like. The activation process is generally performed after the strands have been formed into a nonwoven web or fabric, although it may be done before. The activation process generally stretches the nonwoven web or fabric about 1.1 to 10.0 fold. In advantageous embodiments, the web or fabric is stretched or drawn to about 2.5 times its initial length. The incremental stretching step may include incrementally stretching the web in both the machine direction and the cross-machine direction. Advantageously, incremental stretching may be accomplished by directing the web through at least one pair of interdigitating stretching rollers. In one aspect of such embodiments, the interdigitating stretching rollers give rise to narrow, spaced apart longitudinally extending stretch-activated elastic zones within the fabric, separated by intervening longitudinally extending non-activated zones that are substantially less elastic. The incremental stretching may be accomplished by directing an incrementally stretched web through a second pair of interdigitating stretching rollers to stretch activate a second portion of the non-activated strands within the web. In one advantageous embodiment, an incremental stretch of 400% is preferred. Non-mechanical incremental stretching may be performed in conjunction with an impinging fluid (e.g., air or water) directed onto the surface of the web. Incremental stretching in accordance with the present invention may be accomplished by any means known in the art.

Another advantage would be that the elastic nonwoven material would be effectively married to the elastic film and so not gather or bunch resulting in bulk. Over time, and multiple stretches, the overall integrity of the elastic composite will be far superior to that of a composite produced from an elastic film and non-elastic nonwoven. This would translate in better overall abrasion resistance, sustained nonwoven integrity, and overall general appearance.

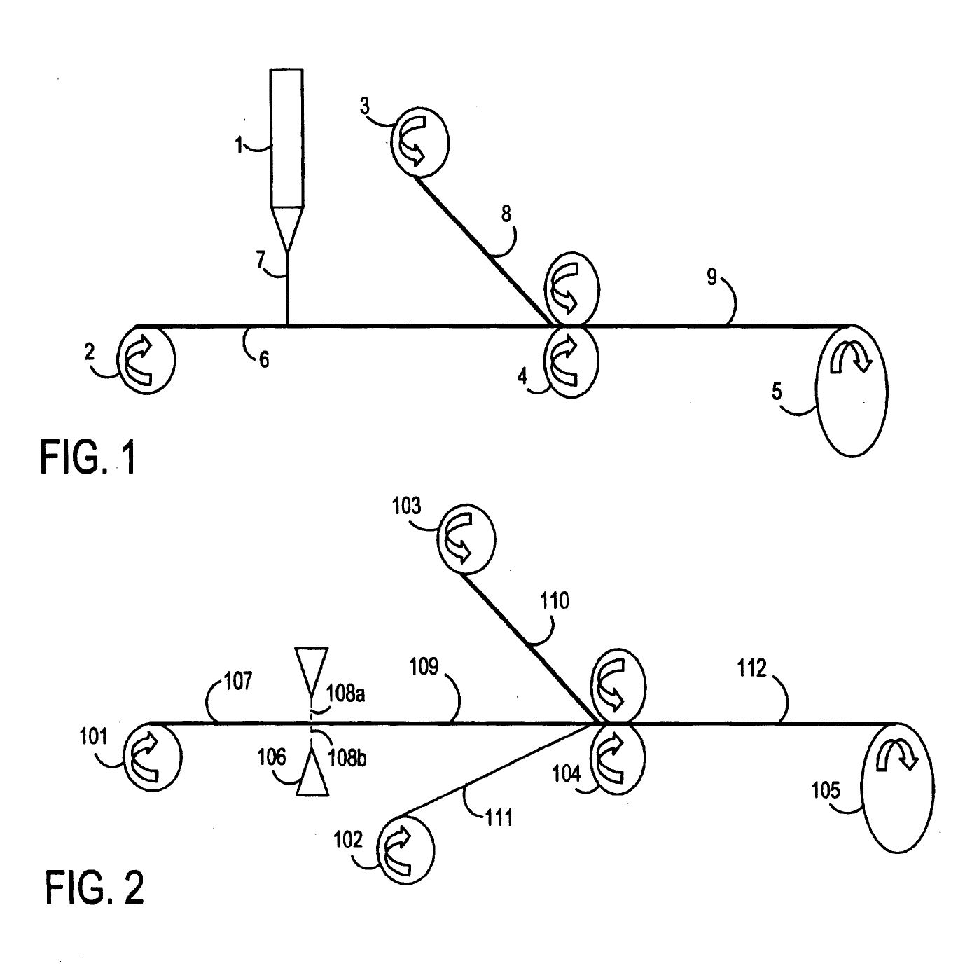

FIGS. 1 and 2 illustrate two methods for preparing the composites. It should be appreciated that, as the figures describe a three layer process, that the inventive composite and process cover all numbers of layers greater than or equal to two. FIG. 1 depicts extrusion lamination to form a composite where an inner elastic film layer is laminated to two outer elastic nonwoven layers. In FIG. 1, a first elastic nonwoven layer 6 is unwound from unwind roll 2. The first elastic nonwoven layer 6 moves forward, with molten elastic polymer 7 (which upon cooling forms the inner elastic film layer being deposited via elastic film melt extruder 1. Next, a second elastic nonwoven layer 8 from second roll 3 is unwound so as to contact the elastic polymer and thereby form a three layer mass which is laminated together via pressure nips 4. The resulting composite 9 is then wound onto laminate rewind roll 5. The process is conducted so that there is neutral tension throughout the process.

It should be appreciated that while it may be simpler to process laminates without differential tension, this invention includes the bonding of a composite of at least one elastic film and at least one elastic nonwoven under differential tension. In this process, either the film or nonwoven or both may be stretched. In this way, the laminate will have more bulk in the rest state (compared to the equivalent, non-tensioned laminate), but will also demonstrate a non-linear elastic extensional force. That is, the force will be dominated by the pre-tensioned member(s) until extension to the pre-tensioned state is achieved, at which point further extension will be under a force which is a sum of all the layers.

In FIG. 2, a melt adhesive lamination process is shown. An elastic film 7 is unwound from film roll 1 and moves forward toward laminate rewind roll 5. Adhesive layers 8a, 8b are applied via melt adhesive sprayers 6 to each side of the elastic film. The adhesive can be a hot melt adhesive. Representative non-limiting examples of commercially available hot melt adhesives include Ato Findley H9282F, Ato Findley H2120, and HP Fuller HL-1470. The adhesive-sprayed elastic film 9 moves forward to pressure nip 4 where a first and a second elastic nonwoven layers 10 and 11 that unwound from nonwoven rolls 2 and 3 are brought into contact with each respective side of the film 9. The layers 10 and 11 are laminated to the film 9 by the pressure from the nip 4, with the resulting composite 12 exiting the nip 4 and wound onto laminate roll 5. The film is maintained under neutral tension during this process (the film and composite are not stretched or otherwise activated).

The temperatures, rate of production, selection of film, selection of adhesive, selection of elastic nonwoven, and so on can be readily selected and/or determined.

The elastic film may comprise either a mono-layer or multi-layer film. In addition, nonporous and microporous films are believed suitable for use with the present invention. Thus, the elastic film can be a monolithic or multilayered film, a net, scrim or foam. The elastic film may comprise a barrier layer and may also exhibit good drape. The elastic films may have a basis weight between about 15 grams per square meter and 100 grams per square meter, and in one embodiment between about 20 grams per square meter and 60 grams per square meter. Thermoplastic polymers used in the fabrication of the elastic films include, but are not limited to, polyolefins including homopolymers, copolymers, terpolymers, and blends thereof. Representative examples of such elastomeric polyolefins include polymers of ethylene, propylene, butylene, pentene, hexene, heptene, and octane, as well as copolymers, terpolymers, and blends thereof. The elastomeric film may also be made with ethylene vinyl acetate (EVA), ethylene ethyl acrylate (EEA), ethylene acrylic acid (EAA), ethylene methyl acrylate (EMA), ethylene butyl acrylate, polyurethane, poly(ether-ester), poly(amid-ether) block copolymers, styrenic block copolymers, such as SBS or SIS or the hydrogenated and fully hydrogenated analogs, and any combination thereof, including combinations with one or more polyolefins.

The film may have additive or blend components to increase water vapor permeability. If porous, the average pore size may or may not increase while stretched. The elastic film may comprise either a mono-layer or multi-layer film. In addition, non-porous and microporous films are believed suitable for use with the present invention. In one embodiment, the film is breathable, as that term is understood in the industry. Breathability can be imparted by selection of materials to make the film, by being porous, by having holes formed through the film, and so on. Breathability can alternatively be imparted during the production of the composite of this invention, such as by stretch activation. The films can be made from moisture permeable or moisture impermeable materials. Some films are made breathable by adding micropore developing filler particles to the film during the film forming process. A micropore developing filler is meant to include particulates and other forms of materials which can be added to a polymer and which will not chemically interfere with or adversely affect the extruded film made from the polymer but are able to be uniformly dispersed throughout the film. Generally, the micropore developing fillers will be in particulate form and usually will have somewhat of a spherical shape with average particle sizes in the range of about 0.5 to about 8 microns. The film will usually contain at least about 30 percent of micropore developing filler based upon the total weight of the film layer. Both organic and inorganic micropore developing fillers are contemplated to be within the scope of the present invention provided that they do not interfere with the film formation process, the breathability of the resultant film or its ability to bond to a fibrous elastic nonwoven web. Examples of micropore developing fillers include calcium carbonate, various kinds of clay, silica, alumina, barium sulfate, sodium carbonate, talc, magnesium sulfate, titanium dioxide, zeolites, aluminum sulfate, cellulose-type powders, diatomaceous earth, magnesium sulfate, magnesium carbonate, barium carbonate, kaolin, mica, carbon, calcium oxide, magnesium oxide, aluminum hydroxide, glass particles, pulp powder, wood powder, cellulose derivative, polymer particles, chitin and chitin derivatives. The micropore developing filler particles may optionally be coated with a fatty acid, such as stearic acid, or a larger chain fatty acid such as behenic acid, which may facilitate the free flow of the particles (in bulk) and their ease of dispersion into the polymer matrix. Silica-containing fillers may also be present in an effective amount to provide antiblocking properties. Once the particle-filled film has been formed, it is then either stretched or crushed to create pathways through the film. Generally, to qualify as being “breathable” for the present invention, the resultant laminate should have a water vapor transmission rate (WVTR) of at least about 250 g/m²/24 hours, typically at 20 C, as may be measured by a test method as described in ASTM E 96-80. In one embodiment the WVTR is at least about 500 g/20 C/m²/24 hours. The term “film” as used herein refers to a thin article and includes strips, tapes, and ribbons of a variety of widths, lengths, and thicknesses. The film is typically flat and has a thickness up to about 50 mils, more typically up to about 10 mils.

Nonwovens are commonly and most economically made by melt spinning thermoplastic materials. Such nonwovens are called “spunbond” or “melt blown” materials and methods for making these polymeric materials are also well known in the field. The spunbond method is economically advantaged over the meltblown, however it is generally understood that it is a more difficult process. While spunbond materials form pure elastomers with desirable combinations of physical properties, especially combinations of softness, strength and durability, have been produced, significant problems are often encountered. The nonwovens employed in this invention are typically and beneficially conjugate fibers and typically bicomponent fibers. In one embodiment the nonwoven is made from bicomponent fibers having a sheath/core structure. In another embodiment the bicomponent fibers are in a tipped, multi-lobed structure. Representative bicomponent, elastic nonwovens and the process for making them, suitable for this invention, are given by Austin in WO 00/08243, incorporated herein by reference in its entirety.

Elastic nonwoven fabrics can be employed in a variety of environments such as bandaging materials, garments such as work wear and medical gowns, diapers, support clothing, incontinence products, diapers, training pants, and other personal hygiene products because of their breathability as well as their ability to allow more freedom of body movement than fabrics with more limited elasticity. Of particular relevance to this invention are articles that form diaper backsheets, protective apparel, medical gowns, and drapes.

As used herein, the term “strand” is being used as a term generic to both “fiber” and filament”. In this regard, “filaments” are referring to continuous strands of material while “fibers” mean cut or discontinuous strands having a definite length. Thus, while the following discussion may use “strand” or “fiber” or “filament”, the discussion can be equally applied to all three terms.

Specifically, what is about to be described hereinbelow for the elastic nonwoven are what we would define as “chemically” elastic fibers. The elastic nonwovens used in the practice of this invention are 2-dimensionally elastic, as understood to one of skill in the art. To those skilled in the art it will be readily apparent the distinction of these fibers from the less elastic, 1-dimensionally elastic, “physical” or “mechanical” elastic nonwovens produced via heat stretching of an otherwise essentially inelastic nonwoven.

The bicomponent strands used to make the elastic nonwoven are typically composed of a first component and a second component. The first component is an “elastic” polymer(s) which refers to a polymer that, when subjected to an extension, deforms or stretches within its elastic limit (i.e., it retracts when released). Many fiber forming thermoplastic elastomers are known in the art and include polyurethanes, block copolyesters, block copolyamides, styrenic block polymers, and polyolefin elastomers including polyolefin copolymers. Representative examples of commercially available elastomers for the first (inner) component include the KRATON polymers sold formerly by Kraton Corp.; ENGAGE elastomers (sold by Dupont Dow Elastomers), VERSIFY elastomers (produced by Dow Chemical) or, VISTAMAXX (produced by Exxon-Mobile Corp.) polyolefin elastomers; and the VECTOR polymers sold by DEXCO. Other elastomeric thermoplastic polymers include polyurethane elastomeric materials (“TPU”), such as PELLETHANE sold by Dow Chemical, ELASTOLLAN sold by BASF, ESTANE sold by B.F. Goodrich Company; polyester elastomers such as HYTREL sold by E.I. Du Pont De Nemours Company; polyetherester elastomeric materials, such as ARNITEL sold by Akzo Plastics; and polyetheramide materials, such as PEBAX sold by Elf Atochem Company. Heterophasic block copolymers, such as those sold by Montel under the trade name CATALLOY are also advantageously employed in the invention. Also suitable for the invention are polypropylene polymers and copolymers described in U.S. Pat. No. 5,594,080.

The second component is also a polymer(s), preferably a polymer which is extensible. Any thermoplastic, fiber forming, polymer would be possible as the second component, depending on the application. Cost, stiffness, melt strength, spin rate, stability, etc will all be a consideration. The second component may be formed from any polymer or polymer composition exhibiting inferior elastic properties in comparison to the polymer or polymer composition used to form the first component. Exemplary non-elastomeric, fiber-forming thermoplastic polymers include polyolefins, e.g. polyethylene (including LLDPE), polypropylene, and polybutene, polyester, polyamide, polystyrene, and blends thereof. The second component polymer may have elastic recovery and may stretch within its elastic limit as the bicomponent strand is stretched. However, this second component is selected to provide poorer elastic recovery than the first component polymer. The second component may also be a polymer which can be stretched beyond its elastic limit and permanently elongated by the application of tensile stress. For example, when an elongated bicomponent filament having the second component at the surface thereof contracts, the second component will typically assume a compacted form, providing the surface of the filament with a rough appearance.

In order to have the best elastic properties, it is advantageous to have the elastic first component occupy the largest part of the filament cross section. In one embodiment, when the strands are employed in a bonded web environment, the bonded web has elongations of at least about 65% after 50% elongation and one pull, as measured independently in both machine direction and cross direction. The root mean square average recoverable elongation is the square root of the sum of (percent recovery in the machine direction)²+percent recovery in the cross machine direction)².

In one respect, where the second component is substantially not elastic resulting in the strand being not elastic as a whole, in one embodiment the second component is present in an amount such that the strand becomes elastic upon stretching of the strand by an amount sufficient to irreversibly alter the length of the second component.

Suitable materials for use as the first and second components are selected based on the desired function for the strand. Preferably, the polymers used in the components of the invention have melt flows from about 5 to about 1000. Generally, the meltblowing process will employ polymers of a higher melt flow than the spunbonded process.

These bicomponent strands can be made with or without the use of processing additives. In the practice of this invention, blends of two or more polymers can be used for either the first component or second component or both.

The first (the elastic component of the present invention) and second components may be present within the multicomponent strands in any suitable amounts, depending on the specific shape of the fiber and end use properties desired. In advantageous embodiments, the first component forms the majority of the fiber, i.e., greater than about 50 percent by weight, based on the weight of the strand (“bos”). For example, the first component may beneficially be present in the multicomponent strand in an amount ranging from about 80 to 99 weight percent bos, such as in an amount ranging from about 85 to 95 weight percent bos. In such advantageous embodiments, the non-elastomeric component would be present in an amount less than about 50 weight percent bos, such as in an amount of between about 1 and about 20 weight percent bos. In beneficial aspects of such advantageous embodiments, the second component may be present in an amount ranging from about 5 to 15 weight percent bos, depending on the exact polymer(s) employed as the second component. In another embodiment, the second component is present in an amount of about 5-10 percent. In one advantageous embodiment, a sheath/core configuration having a core to sheath weight ratio of greater than or equal to about 85:15 is provided, such as a ratio of 95:5.

The shape of the fiber can vary widely. For example, typical fiber has a circular cross-sectional shape, but sometimes fibers have different shapes, such as a trilobal shape, or a flat (i.e., “ribbon” like) shape. Also the fibers, even though of circular cross-section, may assume a non-cylindrical, 3-dimensional shape, especially when stretched and released (self-bulking or self-crimping to form helical or spring-like fibers).

Basis weight refers to the area density of a non-woven fabric, usually in terms of g/m² or oz/yd². Acceptable basis weight for a nonwoven fabric is determined by application in a product. Generally, one chooses the lowest basis weight (lowest cost) that meets the properties dictated by a given product. For elastomeric nonwovens one issue is retractive force at some elongation, or how much force the fabric can apply after relaxation at a certain extension. Another issue defining basis weight is coverage, where it is usually desirable to have a relatively opaque fabric, or if translucent, the apparent holes in the fabric should be of small size and homogeneous distribution. The most useful basis weights in the nonwovens industry for disposable products range from ½ to 4.5 oz/yd² (17 to 150 g/m², or gsm). Some applications, such as durable or semi-durable products, may be able to tolerate even higher basis weights. It should be understood that low basis weight materials may be adventitiously produced in a multiple beam construction. That is, it may be useful to produce an SMS (spunbond/meltblown/spunbond) composite fabric where each of the individual layers have basis weights even less than 17 gsm, but it is expected that the preferred final basis weight will be at least 17 gsm.

The first and second polymeric components can optionally include, without limitation, pigments, antioxidants, stabilizers, surfactants, waxes, flow promoters, solid solvents, particulates and material added to enhance processability of the composition.

It should be appreciated that an elastic material or elastic-like nonwoven, as applicable to this invention, typically refers to any material having a root mean square average recoverable elongation of about 65% or more based on machine direction and cross-direction recoverable elongation values after 50% elongation of the web and one pull. The extent that a material does not return to its original dimensions after being stretched and immediately released is its percent permanent set. According to ASTM testing methods, set and recovery will add to 100%. Set is defined as the residual relaxed length after an extension divided by the length of extension (elongation). For example, a one inch gauge (length) sample, pulled to 200% elongation (two additional inches of extension from the original one inch gauge) and released might a) not retract at all so that the sample is now three inches long and will have 100% set ((3″_{end}−1″ᵢₙᵢₜᵢₐₗ)/2″ₑₓₜₑₙₛᵢₒₙ), or b) retract completely to the original one inch gauge and will have 0% set ((1″_{end}−1″ᵢₙᵢₜᵢₐₗ)/2″ₑₓₜₑₙₜᵢₒₙ), or c) will do something in between. An often used and practical method of measuring set is to observe the residual strain (recovery) on a sample when the restoring force or load reaches zero after it is released from an extension. This method and the above method will only produce the same result when a sample is extended 100%. For example, as in the case above, if the sample did not retract at all after 200% elongation, the residual strain at zero load upon release would be 200%. Clearly in this case set and recovery will not add to 100%. By contrast, a non-elastic nonwoven does not meet these criteria.

The novel elastic fiber of the present invention can be used with other fibers such as PET, Nylon, polyolefins and cotton to make elastic fabrics. One example is multifilament, multicomponent tows bundled to produce a yarn which is stretch-activated to permanently elongate the inelastic component. This process produces an elastic yarn with surprising softness, or hand, which is nothing like either of the individual components. This is surprisingly true even in the case of multicomponent fibers.

Fiber diameter can be measured and reported in a variety of fashions. Generally, fiber diameter is measured as a linear density in terms of denier per filament, or more simply as a width in microns. Denier is a textile term that is defined as the grams of the fiber per 9000 meters of that fiber's length. Monofilament generally refers to an extruded single strand having a denier per filament greater than 15, usually greater than 30. Fine denier fiber generally refers to fiber having a denier of about 15 or less. Microfiber generally refers to fiber having a diameter not greater than about 100 micrometers. For the present SBCs, assuming a typical solid density of 0.92 g/cm³, a 100 micron diameter, pure monofilament fiber would have a denier of 65. In the case of blends or multicomponent fibers, the solid density must be measured or calculated to convert denier to micron diameter. For the inventive elastic fibers disclosed herein, the diameter can be widely varied. The fiber denier can be adjusted to suit the capabilities of the finished article. Expected fiber diameter values would be: from about 5 to about 20 microns/filament for melt blown; from about 10 to about 50 micron/filament for spunbond; and from about 20 to about 200 micron/filament for continuous wound filament. Strands of any diameter are possible with the present materials, though are typically less than 450 microns. For apparel applications, the typical nominal denier is greater than 37, in other embodiments greater than or equal to 55 or greater than or equal to 65. These deniers may be made up from multiple filaments (tows) as well as monofilaments. Typically, durable apparel employ fibers or fiber tows with deniers greater than or equal to about 40. For disposable nonwoven applications, the diameter of the fiber can be below 75 microns, below 50 microns, or below 35 microns. Typically, in a nonwoven, the finer the fiber the better the distribution or coverage across the fabric for a given basis weight (weight of fibers per square area of fabric, for example in grams per square meter).

For elastic fibers it is typically the case that the same diameters are not achievable as with non-elastic materials. This is due to the nature of elastics as soft materials with very low T_{g} components. Therefore during spinning, elastomers tend to “snap back” as soon as the draw tension is released, which results in an increase in the fiber diameter. Fine fibers (<40 microns in diameter) are readily achievable with good elasticity and small fibers (<10 microns) may be achieved with low elastic blends or multicomponent fibers with higher percentages of non-elastic components, for example by forming a bicomponent fiber with a high percentage of non-elastomer and then splitting the fiber to produce fibrils of elastomer and nonelastomer.

A nonwoven composition or article is typically a web or fabric having a structure of individual fibers or threads which are randomly interlaid, but not in an identifiable manner as is the case for a woven or knitted fabric. The elastic fiber of the present invention can be employed to prepare inventive nonwoven elastic fabrics as well as composite structures comprising the elastic nonwoven fabric in combination with non-elastic materials. The inventive nonwoven elastic fabrics may include bicomponent fibers made using the elastomeric materials described herein and non-elastomeric polymers, such as polyolefins.

While the principal components of the multi-component strands of the present invention have been described above, such polymeric components can also include other materials which do not adversely affect the multi-component strands. For example, the first and second polymeric components can also include, without limitation, pigments, antioxidants, stabilizers, surfactants, waxes, flow promoters, solid solvents, particulates and material added to enhance processability of the composition.

Nonwoven webs can be produced by techniques that are recognized in the art. A class of processes, known as spunbonding is the most common method for forming spunbonded webs. Examples of the various types of spunbonded processes are described in U.S. Pat. No. 3,338,992 to Kinney, U.S. Pat. No. 3,692,613 to Dorschner, U.S. Pat. No. 3,802,817 to Matsuki, U.S. Pat. No. 4,405,297 to Appel, U.S. Pat. No. 4,812,112 to Balk, and U.S. Pat. No. 5,665,300 to Brignola et al.

All of the spunbonded processes of this type can be used to make the elastic fabric of this invention if they are outfitted with a spinneret and extrusion system capable of producing bicomponent filaments. However, one preferred method involved providing a drawing tension from a vacuum located under the forming surface. This method provides for a continually increasing strand velocity to the forming surface, and so provides little opportunity for elastic strands to snap back.

Another class of process, known as meltblowing, can also be used to produce the nonwoven fabrics of this invention. This approach to web formation is described in NRL Report 4364 “Manufacture of Superfine Organic Fibers” by V. A. Wendt, E. L. Boone, and C. D. Fluharty and in U.S. Pat. No. 3,849,241 to Buntin et al.

Any meltblowing process which provides for the extrusion of bicomponent filaments such as that set forth in U.S. Pat. No. 5,290,626 can be used to practice this invention.

The invention will now be described in terms of certain preferred examples thereof. It is to be recognized, however, that these examples are merely illustrative in nature and should in no way limit the scope of the present invention.

### EXAMPLE 1

This material is a elastic nonwoven/elastic film/elastic nonwoven composite produced via adhesive lamination generally in accordance with the method described in FIG. 2. The two elastic nonwoven layers were produced via a bicomponent spunbond process generally in accordance with the method outlined above. The inner first component is a thermoplastic polyurethane (TPU) or a styrene/isoprene/styrene block copolymer (SIS) and the second outer component is a polypropylene. The fiber configuration is sheath/core of varying percentages. The elastic film is a SBS based film of 50 and 90 microns in thickness. The control material is a non-elastic nonwoven/elastic film laminate, a standard in the industry, that has been mechanically activated. In Table 1, “NW” refers to nonwoven, “BW” refers to basis weight, and “CD” refers to cross-machine direction.

TABLE 1

| | | | | | Elong. | | | |
|---|---|---|---|---|---|---|---|---|
| | | | | | at | | | |
| | | BW of | Film | Fmax | Break | Load at | Load at | Permanent |
| | NW | NW | Thickness | CD | CD | 50% CD | 100% CD | Set |
| Sample | Composition | (gsm) | (μm) | (N/in) | (%) | (N/60 mm) | (N/60 mm) | CD (%) |
| Control | PP | 2 × (25) | 110 | 59 | 1375 | 10 | 14 | 6.4 |
| 1 | 85% | 2 × (25) | 90 | 25 | 1260 | 9.2 | 11 | 12 |
| | SIS/15% PP | | | | | | | |
| 2 | 90% | 2 × (25) | 90 | 49 | 1560 | 24 | 31 | 15 |
| | TPU/10% | | | | | | | |
| | PP | | | | | | | |
| 3 | 95% | 2 × (25) | 90 | 48 | 1480 | 17 | 21 | 12 |
| | TPU/5% PP | | | | | | | |
| 4 | 90% | 2 × (25) | 50 | 31 | 1280 | 16 | 21 | 22 |
| | TPU/10% | | | | | | | |
| | PP | | | | | | | |
| 5 | 95% | 2 × (25) | 50 | 28 | 1190 | 10 | 12 | 16 |
| | TPU/5% PP | | | | | | | |

The results of table 1 show that fully elastic nonwovens result in the following improvements over current products: elimination of the need for any and all pre-activation steps of the nonwoven, improved abrasion resistance and conformity of the nonwoven as a composite, and comparable overall elastic performance of the composite at significantly reduced film thickness.

### EXAMPLE 2

Composites that are an elastic nonwoven/elastic film/elastic nonwoven laminate produced via extrusion lamination generally in accordance with the method described in FIG. 1. The two elastic nonwoven layers were produced via a bicomponent spunbond process generally in accordance with the method outlined above. The spunbonded nonwovens are “as spun” and have not been further stretch activated. The inner first component of the bicomponent fibers making up the spunbond nonwovens is a thermoplastic polyurethane (TPU) and the second outer component is a polyethylene. The fiber configuration is sheath/core of 95/5 core/sheath ratio. The elastic film is based on a blend of AFFINITY polyolefin plastomers and the thickness is varied in each example, as outlined in Tables 2 and 3. The films of these examples has not been further processed or activated. Another inventive material compared in the Table is an elastic nonwoven/elastic perforated film laminate, that has been adhesively laminated, such as those listed in Example 1 and Table 1. In all inventive examples, the composite has not been further processed or activated before determination of the properties given in the tables. In Tables 2-3, “NW” refers to nonwoven, “BW” refers to basis weight, and “CD” refers to cross-machine direction.

TABLE 2
Elastic Properties of elastic laminates.

| | | | | | Retractive | Retractive | | Stress |
|---|---|---|---|---|---|---|---|---|
| | | BW of | | Film | Force @ | Force @ | Permanent | Relaxation |
| | NW | NW | Film | Thickness | 30% (g) | 50% (g) | Set (%) | (%) |
| Sample | Composition | (gsm) | Composition | (μm) | (MD/CD) | (MD/CD) | (MD/CD) | (MD/CD) |
| 1 | 95% TPU/5% | 2 × 25 | AFFINITY | 15 | 96/24 | 283/100 | 17/21 | 17/15 |
| | PE | | PE | | | | | |
| 2 | 95% TPU/5% | 2 × 25 | AFFINITY | 25 | 123/42 | 335/153 | 17/20 | 16/15 |
| | PE | | PE | | | | | |
| 3 | 95% TPU/5% | 2 × 25 | AFFINITY | 35 | 238/121 | 555/352 | 17/19 | 15/14 |
| | PE | | PE | | | | | |
| 4 | 95% TPU/5% | 2 × 25 | AFFINITY | 65 | 378/163 | 769/388 | 15/16 | 13/14 |
| | PE | | PE | | | | | |
| 5 | 95% TPU/5% | 25 | Perforated | 82 | 190/110 | 590/210 | 19/13 | 17/14 |
| | PE | | film | | | | | |
| | | | Adhesive | | | | | |
| | | | lamination | | | | | |

TABLE 3
Tensile properties of elastic laminates

| | | BW of | | Film | Force @ | Force @ | | Peak |
|---|---|---|---|---|---|---|---|---|
| | NW | NW | Film | Thickness | 10% (N) | 50% (N) | Max Force | Elongation |
| Sample | Composition | (gsm) | Composition | (μm) | (MD/CD) | (MD/CD) | (N) | (%) |
| 1 | 95% | 2 × 25 | AFFINITY PE | 15 | 4/1 | 12/3 | 41/14 | 189/318 |
| | TPU/5% PE | | | | | | | |
| 2 | 95% | 2 × 25 | AFFINITY PE | 25 | 5/2 | 14/5 | 41/17 | 182/345 |
| | TPU/5% PE | | | | | | | |
| 3 | 95% | 2 × 25 | AFFINITY PE | 35 | 8/6 | 19/11 | 65/33 | 233/413 |
| | TPU/5% PE | | | | | | | |
| 4 | 95% | 2 × 25 | AFFINITY PE | 65 | 8/6 | 20/11 | 73/35 | 260/415 |
| | TPU/5% PE | | | | | | | |
| 5 | 95% | 25 | Perforated | 82 | 12/2 | 35/5 | 72/30 | 160/550 |
| | TPU/5% PE | | film Adhesive | | | | | |
| | | | lamination | | | | | |

The results of Tables 2 and 3 show that fully elastic nonwovens produced via the inventive extrusion process are even more effective as an elastic laminate as the inventive adhesive laminates described in Example 1. One advantage of the extrusion lamination is the ability to achieve similar properties to the traditional adhesive laminate but at much reduced film weights. As with the fully elastic adhesive laminate of Example 2, the fully elastic extrusion laminate results in the following improvements over current products: elimination of the need for any and all pre-activation steps of the nonwoven, improved abrasion resistance and conformity of the nonwoven as a composite, and comparable overall elastic performance of the composite at significantly reduced film thickness.

Further modifications and alternative embodiments of this invention will be apparent to those skilled in the art in view of this description. Accordingly, this description is to be construed as illustrative only and is for the purpose of teaching those skilled in the art the manner of carrying out the invention. It is to be understood that the forms of the invention herein shown and described are to be taken as illustrative embodiments. Equivalent elements or materials may be substituted for those illustrated and described herein, and certain features of the invention may be utilized independently of the use of other features, all as would be apparent to one skilled in the art after having the benefit of this description of the invention.

1. An elastic multilayer composite, comprising an elastic film adjacent to an elastic nonwoven layer.

2. The elastic multilayer composite of claim 1 being a trilayer composite, wherein the film is sandwiched between the elastic nonwoven layer and a second elastic nonwoven layer.

3. The elastic multilayer composite claim 1, wherein the composite is bonded via adhesive, extrusion lamination, or thermopoint bonding.

4. The elastic multilayer composite claim 1, wherein the elastic film is a monolithic or multilayered film, a net, a scrim, or a foam.

5. The elastic multilayer composite claim 1, wherein the elastic film is breathable or made breathable by activation.

6. The elastic multilayer composite of claim 1, wherein the film has a water vapor transmission rate of at least about 300 g/20 C/m²/day.

7. The elastic multilayer composite of claim 2, wherein the first and/or second nonwoven layer is formed of bicomponent fibers, wherein the bicomponent fibers include an inner first component and an outer second component, wherein the first component is a thermoplastic elastomer, wherein the first component comprises at least 50% of the fibers, and wherein the second component is polyethylene, polypropylene, or a blend of polyethylene and polypropylene.

8. The elastic multilayer composite of claim 2, wherein first and/or second nonwoven layers are composed of bicomponent fibers having a sheath/core, multi-lobal, or tipped multi-lobal structure.

9. The elastic multilayer composite of claim 2, wherein the first and/or second nonwoven layers are composed of bicomponent fibers which have not been activated.

10. The elastic multilayer composite of claim 2, wherein the first and/or second nonwoven layers are composed of bicomponent fibers which have been stretch activated.

11. The elastic multilayer composite of claim 2, wherein the first and/or second nonwoven layers are any one of spunbonded, meltblown, carded, or airlaid nonwovens.

12. The elastic multilayer composite of claim 1, wherein the composite has been stretch activated.

13. The elastic multilayer composite of claim 1, wherein film is breathable.

14. The elastic multilayer composite of claim 1, wherein the film is stretch activated to impart breathability or water vapor transport, either as the film prior to lamination or in the composite.

15. A process for manufacturing an elastic multilayer composite, comprising: bonding under neutral tension an elastic film layer to a first elastic nonwoven layer.

16. The process of claim 15, wherein a second elastic nonwoven layer is bonded to the elastic layer, and wherein the elastic film layer is sandwiched between the first and second nonwoven layers.

17. The process of claim 15, wherein adhesive is between the elastic film layer and the first elastic nonwoven layer.

18. The process of claim 16, wherein adhesive is between the elastic film layer and the first elastic nonwoven layer and wherein an adhesive is between the elastic film layer and the second elastic nonwoven layer.

19. The process of claim 15, wherein the elastic film layer is extrusion laminated to the first elastic nonwoven layer.

20. The process of claim 16, wherein the elastic film layer is extrusion laminated to the first elastic nonwoven layer, and wherein an adhesive or further lamination occurs to bond the elastic film layer and the second elastic nonwoven layer.

21. The process of claim 15, wherein the elastic film layer is fixed to the elastic nonwoven layer at a plurality of points via thermopoint bonding.

22. The process of claim 16, wherein the elastic film layer is fixed to the first and second elastic nonwoven layers at a plurality of points via thermopoint bonding.

23. The process of claim 15 wherein the first and/or second nonwoven layer is formed of bicomponent fibers, wherein the bicomponent fibers include an inner first component and an outer second component, wherein the first component is a thermoplastic elastomer, wherein the first component comprises at least 50% of the fibers, and wherein the second component is polyethylene, polypropylene, or a blend of polyethylene and polypropylene.

24. The process of claim 15, wherein any nonwoven layer is composed of bicomponent fibers having a sheath/core, multilobal, or tipped multilobal structure.

25. The process of claim 15, wherein any nonwoven layer is composed of bicomponent fibers which has not been activated.

26. The process of claim 15, wherein any nonwoven layer is composed of bicomponent fibers which has been stretch activated.

27. The process of claim 15, wherein the composite is stretch activated.

28. The process of claim 15, wherein the bonding occurs by melt adhesive lamination.

29. The process of claim 15, wherein any nonwoven layer have a tensile strength less than the tensile of the elastic film.

30. An article comprising the composite of claim 1.

31. The article of claim 30, wherein the article is a bandaging material, workwear, a medical gown, a diaper, a support clothing, an incontinence product, or training pants.

32. The article of claim 41, wherein the composite is made by the process of claim 15.

33. A composite made by the process of claim 15.

34. The composite of claim 1 made by the process of claim 15.
